(19) United States
(12) Patent Application Publication
(10) Pub. No.: US 2022/0105851 A1
(43) Pub. Date: Apr. 7, 2022

(54) DETACHABLE CUP HOLDER ON INBOARD SIDE SHIELD OF VEHICLE SEAT

(71) Applicant: Toyota Boshoku America, Inc., Novi, MI (US)

(72) Inventor: Vishnu Patil, Pune (IN)

(21) Appl. No.: 17/490,509

(22) Filed: Sep. 30, 2021

Related U.S. Application Data
(60) Provisional application No. 63/087,722, filed on Oct. 5, 2020.

(51) Int. Cl. B60N 3/10

(52) U.S. Cl. CPC B60N 3/103

(57) ABSTRACT

A vehicle seat assembly includes an adapter including a first attachment feature and a cup holder including a second attachment feature. The first attachment feature engages with the second attached feature to removably secure the cup holder to the adapter.

### CROSS-REFERENCE TO RELATED APPLICATION

This application claims the benefit of U.S. Provisional Application No. 63/087,722 filed on Oct. 5, 2020.

### BACKGROUND

A cup holder is used in a vehicle to hold a beverage.

### SUMMARY

In one example, a vehicle seat assembly includes an adapter including a first attachment feature and a cup holder including a second attachment feature. The first attachment feature engages with the second attached feature to removably secure the cup holder to the adapter.

In another embodiment, the vehicle seat assembly includes a side shield configured to be attached to a seat cushion of a vehicle seat.

In another embodiment, the side shield defines a recess, and the adapter is received in the recess of the side shield.

In another embodiment, the side shield includes a stop.

In another embodiment, the stop includes a flat portion, and the cup holder rests on the flat portion of the stop.

In another embodiment, the first attachment feature comprises a pair of arms defining a space therebetween and the second attachment feature comprises a body, and the body is received in the space between the pair of arms to secure the cup holder to the adapter.

In another embodiment, each of the pair of arms is substantially curved and defines a recess and the body includes a pair of projections, and one of the pair of projections is received in one of the recesses.

In another embodiment, the pair of arms of the adapter are flexible.

In another embodiment, the adapter and the side shield are made of polyethylene or polypropylene.

In another embodiment, the cup holder is detachable from the adapter.

In another example, a vehicle seat assembly includes a side shield configured to be attached to a seat cushion of a vehicle seat and an adapter including a first attachment feature. The side shield includes a recess and a stop, and the first attachment feature includes a pair of arms defining a space therebetween. The adapter is attached to the recess of the side shield. The vehicle seat assembly includes a cup holder including a second attachment feature, and the second attachment feature includes a body. The first attachment feature engages with the second attachment feature to secure the cup holder to the adapter. The body is received in the space between the pair of arms to secure the cup holder to the adapter.

In another embodiment, the stop includes a flat portion, and the cup holder rests on the flat portion of the stop.

In another embodiment, each of the pair of arms is substantially curved and defines a recess and the body includes a pair of projections, and one of the pair of projections is received in one of the recesses.

In another embodiment, the cup holder is detachable from the adapter.

In another embodiment, the pair of arms of the adapter are flexible.

In another embodiment, the adapter and the side shield are made of polyethylene or polypropylene.

### BRIEF DESCRIPTION OF THE DRAWINGS

FIG. 1 illustrates a side shield of a vehicle seat;

FIG. 2 illustrates an adapter to be attached to the side shield of the vehicle seat;

FIG. 3 illustrates the attachment of the adapter in a recess in the side shield;

FIG. 4 illustrates a cup holder to be attached to the adapter; and

FIG. 5 illustrates a vertical load applied to the cup holder relative to the adapter.

### DETAILED DESCRIPTION

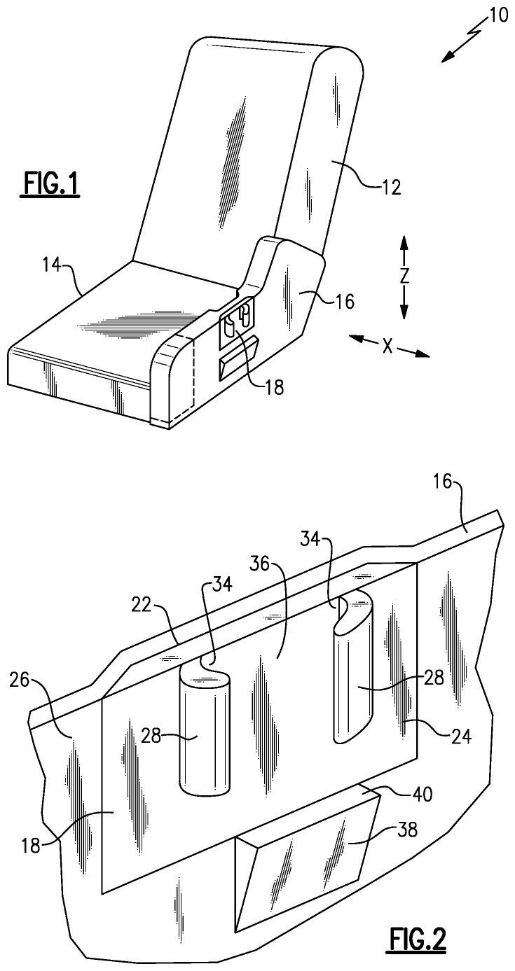

FIG. 1 illustrates a vehicle seat 10 including a seat back 12 and a seat cushion 14. An inboard side shield 16 is attached to an outer side of the seat cushion 14 of the vehicle seat 10. In one example, the side shield 16 is made of plastic. In one example, the side shield 16 is made of polyethylene or polypropylene.

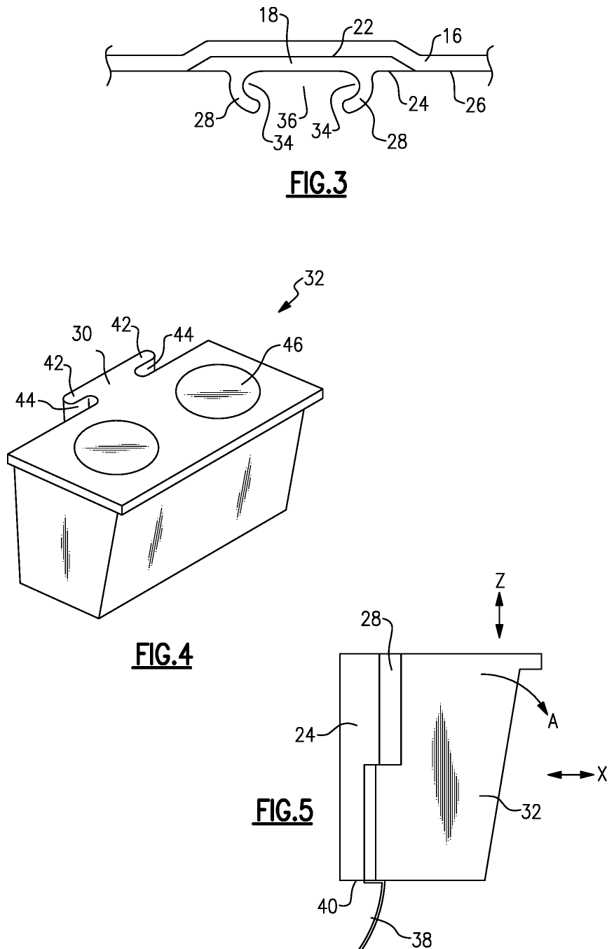

FIG. 2 illustrates an adapter 18 attached to the side shield 16. As shown in FIG. 3, the side shield 16 includes a recess 22, and an adapter 18 is received in the recess 22 of the side shield 16. As also shown, a front surface 24 of the adapter 18 is substantially flush with a front surface 26 of the side shield 16 when the adapter 18 is received in the recess 22 of the side shield 16. The adapter 18 is part of the side shield 16 and is molded in the same tool/process as the side shield 16. In one example, the adapter 18 is made of polyethylene or polypropylene.

The adapter 18 includes a pair of arms 28 that receive an attachment feature 30 of a cup holder 32 (described below) that is received between the pair of arms 28. In one example, the arms 28 are made of polyethylene or polypropylene and are flexible. The arms 28 each curve inwardly toward each other, and a recess 34 is defined between each arm 28 and the adapter 18. A space 36 is defined between the curved portions of the arms 28 and by the recesses 34. In another example, the adapter 18 includes the attachment feature 30, and the cup holder 32 includes the pair of arms 28. The attachment feature 30 is sized and shaped to fit between the pair of arms 28 to retain the adapter 18 to the side shield 16.

The side shield 16 also includes a stop 38 under arms 28 that stops the insertion of the cup holder 32 in the downward vertical direction. In one example, the stop 38 is substantially wedged shape such that a flat portion 40 of the stop 38 is located under the arms 28. In one example, the cup holder 32 rests on the flat portion 40 of the stop 38 when the attachment feature 30 is received in the space 36.

As shown in FIG. 4, the cup holder 32 includes the attachment feature 30 that is slidably received between the pair of arms 28 of the adapter 18. The attachment feature 30 includes a body and two outwardly extending projections 42, and a recess 44 is located between each of the projections 42 and the cup holder 32. When the cup holder 32 is attached to the adapter 18, the arms 28 are reach received in one of the recesses 44. As stated above, in another example, the adapter 18 includes the attachment feature, and the cup holder 32 includes the pair of arms. The attachment feature 30 is received in the space 36 between the arms 28 such that each of the projections 42 is received in the recess 34 of one of the arms 28.

The cup holder 32 is detachable from the adapter 18 and can be removed or located selectively in case of spacial constraints. In one example, the cup holder 32 includes one recess 46 for a cup (not shown). In another example, the cup holder 32 includes two recesses 46 that each receive a cup.

As shown in FIG. 5, the adapter 18 and the side shield 16 are installed in a fore-aft direction X, and the cup holder 32 are installed and removed from the adapter 18 in a vertical direction Z. However, the cup holder 32 is designed to withstand an abuse load in both the fore-aft direction X and the vertical direction Z without damaging the side shield 16 (shown in FIG. 5). If a load is accidentally applied in the vertical direction Z, the flexible arms 28 of the adapter 18 can bend to automatically detach the cup holder 32 from the adapter 18 without damaging the adapter 18 or the side shield 16, and the cup holder 32 pivots in the direction A to disengage from the adapter 18. Additionally, if a load is applied in the fore-aft direction X, the adapter 18 automatically detaches from the side shield 16 without damaging the side shield 16.

There are no protruding surfaces when entering or leaving a vehicle as there are no protruding edges on the side shield 16. As the assembly is three pieces (the side shield 16, the adapter 18, and the cup holder 32), there is a cost savings as there is a reduced need for tooling for secondary operations. Heat stacking and screws are not required, and complex tooling such as lifters and sliders are also not required. There is also a time savings during installation, and it is easy to change components as only one component needs to be changed at a time.

The foregoing description is only exemplary of the principles of the disclosure. Many modifications and variations of the present disclosure are possible in light of the above teachings. The preferred embodiments of this disclosure have been disclosed, however, so that one of ordinary skill in the art would recognize that certain modifications would come within the scope of this disclosure. It is, therefore, to be understood that within the scope of the appended claims, the disclosure may be practiced otherwise than as specifically described. For that reason, the following claims should be studied to determine the true scope and content of this disclosure.

What is claimed is:

1. A vehicle seat assembly comprising:
an adapter including a first attachment feature; and
a cup holder including a second attachment feature, wherein the first attachment feature engages with the second attached feature to removably secure the cup holder to the adapter.

2. The vehicle seat assembly as recited in claim 1 including a side shield configured to be attached to a seat cushion of a vehicle seat.

3. The vehicle seat assembly as recited in claim 2 wherein the side shield defines a recess, and the adapter is received in the recess of the side shield.

4. The vehicle seat assembly as recited in claim 3 wherein the side shield includes a stop.

5. The vehicle seat assembly as recited in claim 5 wherein the stop includes a flat portion, and the cup holder rests on the flat portion of the stop.

6. The vehicle seat assembly as recited in claim 1 wherein the first attachment feature comprises a pair of arms defining a space therebetween and the second attachment feature comprises a body, and the body is received in the space between the pair of arms to secure the cup holder to the adapter.

7. The vehicle seat assembly as recited in claim 6 wherein each of the pair of arms is substantially curved and defines a recess and the body includes a pair of projections, and one of the pair of projections is received in one of the recesses.

8. The vehicle seat assembly as recited in claim 6 wherein the pair of arms of the adapter are flexible.

9. The vehicle seat assembly as recited in claim 1 wherein the adapter and the side shield are made of polyethylene or polypropylene.

10. The vehicle seat assembly as recited in claim 1 wherein the cup holder is detachable from the adapter.

11. A vehicle seat assembly comprising:
a side shield configured to be attached to a seat cushion of a vehicle seat, wherein the side shield includes a recess and a stop;
an adapter including a first attachment feature, wherein the first attachment feature comprises a pair of arms defining a space therebetween and the adapter is attached to the recess of the side shield; and
a cup holder including a second attachment feature, wherein the second attachment feature comprises a body, the first attachment feature engages with the second attachment feature to secure the cup holder to the adapter, and the body is received in the space between the pair of arms to secure the cup holder to the adapter.

12. The vehicle seat assembly as recited in claim 11 wherein the stop includes a flat portion, and the cup holder rests on the flat portion of the stop.

13. The vehicle seat assembly as recited in claim 12 wherein each of the pair of arms is substantially curved and defines a recess and the body includes a pair of projections, and one of the pair of projections is received in one of the recesses.

14. The vehicle seat assembly as recited in claim 11 wherein the cup holder is detachable from the adapter.

15. The vehicle seat assembly as recited in claim 11 wherein the pair of arms of the adapter are flexible.

16. The vehicle seat assembly as recited in claim 11 wherein the adapter and the side shield are made of polyethylene or polypropylene.
